(19) United States
(12) Patent Application Publication
(10) Pub. No.: US 2025/0312814 A1
(43) Pub. Date: Oct. 9, 2025

(54) FLUID EJECTION HEAD THERMAL REGULATION

(71) Applicant: Funai Electric Co., Ltd., Osaka (JP)

(72) Inventors: Adam D. CARRITHERS, Lexington, KY (US); Bruce D. GIBSON, Lexington, KY (US)

(73) Assignee: Funai Electric Co., Ltd., Osaka (JP)

(21) Appl. No.: 18/626,785

(22) Filed: Apr. 4, 2024

(51) Int. Cl. B05C 11/10

(52) U.S. Cl. CPC B05C 11/1005; B05C 11/1042

(57) ABSTRACT

A fluid cartridge and method for heating or cooling fluid in the fluid cartridge. The fluid cartridge includes a cartridge body containing the fluid and has a bottom wall having a fluid supply opening therein. A metal insert is adhesively fastened to the bottom wall of the cartridge body. The metal insert has a fluid supply slot therein corresponding to the fluid supply opening in the bottom wall, a die bond surface adjacent to the fluid supply slot configured for adhesively fastening an ejection head chip thereto, and a heat transfer device selected from a heating element embedded in the metal insert and one or more thermal contact extensions. An ejection head chip is adhesively fastened to the die bond surface of the metal insert.

### TECHNICAL FIELD

The disclosure is directed to fluid supply cartridges for fluid ejection devices and in particular to fluid supply cartridges that provide improved thermal properties for ejecting thermally sensitive fluids.

### BACKGROUND AND SUMMARY

For temperature sensitive fluids, such as medicines, it is necessary to store cartridges in refrigerated environments—sometimes at sub-freezing temperatures. FIG. 1 illustrates the mass of fluid delivered as a function of time (in hours) for an ejection head that has been removed from a refrigeration unit. A thermocouple was used to record the internal temperature of the fluid in the cartridge over time. As shown in FIG. 1, the volume of fluid dispensed for a given dispense event correlates closely to the temperature of the bulk fluid in the cartridge, which rises after the cartridge is removed from cold storage.

During operation of the cartridge, thermal energy is coupled into the fluid and is carried away by the fluid droplets as they are dispensed from the ejection head chip. Heat which is not dissipated by the dispensed droplets conducts back into the cartridge body and bulk fluid supply. For a given fluid there is an optimum temperature for operation, typically between 40° C. and 60° C., and this specified temperature can usually be reached in under a second by using the heaters on the ejection head chip. When the ejection head chip is operated at high frequencies heat may not be removed from the ejection head chip quickly enough to maintain the optimum dispense temperature. If the steady state temperature of the fluid is too high, cooling of the bulk fluid supply may be necessary.

When the bulk fluid temperature of a refrigerated fluid ejection cartridge is much lower than the ambient temperature, an energy input is necessary to heat the fluid to the optimal pre-firing temperature prior to reaching the fluid ejection chamber of the ejection head. Not only does the colder fluid temperature affect the physical properties of the fluid, but the fluid requires more energy to nucleate—thus reducing jetting performance and consistency.

For some thermal sensitive fluids, it is not practical for a refrigerated or frozen fluid cartridge to thaw over time prior to use. Furthermore, extended times at elevated temperatures can compromise the integrity of temperature sensitive fluids, reducing their efficacy. Conventional methods for heating the bulk fluid include placing a heating element directly into the main fluid reservoir of the fluid cartridge. However, direct, and prolonged exposure to a heating element with a high heat flux, such as a resistance heating wire, is not practical for temperature sensitive fluids and risk making the fluids unusable for their intended purpose. Accordingly, what is needed is a means to effectively, and consistently heat or cool the fluid to be ejected prior to the fluid entering the fluid ejection head to provide optimal pre-jetting temperatures which result in a more consistent steady-state fluid jetting temperatures.

In view of the foregoing, embodiments of the disclosure provide a fluid cartridge and method for heating or cooling fluid in the fluid cartridge. The fluid cartridge includes a cartridge body containing the fluid and has a bottom wall having a fluid supply opening therein. A metal insert is adhesively fastened to the bottom wall of the cartridge body. The metal insert has a fluid supply slot therein corresponding to the fluid supply opening in the bottom wall, a die bond surface adjacent to the fluid supply slot configured for adhesively fastening an ejection head chip thereto, and a heat transfer device selected from a heating element embedded in the metal insert and one or more thermal contact extensions. An ejection head chip is adhesively fastened to the die bond surface of the metal insert.

In another embodiment, there is provided a method for heating a fluid in a fluid cartridge. The method includes providing a cartridge body containing the fluid having a bottom wall having a fluid supply opening therein. A metal insert is attached to the bottom wall of the cartridge body, wherein the metal insert has a fluid supply slot therein corresponding to the fluid supply opening in the bottom wall, a die bond surface adjacent to the fluid supply slot, and a heat transfer device selected from the group consisting of a heating element embedded in the metal insert and one or more thermal contact extensions. An ejection head chip is attached to the die bond surface of the metal insert. The metal inserted is heated using the heat transfer device to adjust a temperature of the fluid being fed to the ejection head from the fluid body through the metal insert.

In another embodiment, there is provided a method for heating or cooling a fluid in a fluid cartridge. The method includes providing a cartridge body containing the fluid having an ejection head bonded to a die bond surface of a metal insert attached to the fluid cartridge. A metal insert is heated or cooled to heat or cool the fluid on a side of the metal insert opposite the die bond surface of the metal insert.

In some embodiments, a metal of the metal insert is selected from aluminum, steel, copper, tantalum, titanium, and alloys of two or more of the foregoing. In other embodiments, the metal insert is aluminum.

In some embodiments, the one or more thermal contact extensions are configured to be in thermal contact with a thermoelectric device. In some embodiments, the thermoelectric device is activated to heat or cool the fluid in the fluid body. In other embodiments, the one or more thermal contact extensions include a first thermal contact extension on a first side of the metal insert, and a second thermal contact extension on a second side of the metal insert, wherein the first and second thermal contact extensions are adjacent to opposing sides of the cartridge body. The thermal contact extensions may be included in an external temperature control system, such as a radiant cooling system.

In some embodiments, a side of the metal insert opposite the die bond surface of the metal insert further includes heat transfer protrusions thereon.

In some embodiments, the heating element is embedded in a groove adjacent to three sides of the die bond surface of the metal insert. In other embodiments, the heating element comprises a material selected from the group consisting of FeCrAl alloys, NiCr alloys, NiFe alloys, CuNi alloys, and the like. In other embodiments, contact pads for the heating element are disposed on a tab circuit side of the fluid cartridge. In some embodiments, the heating element is activated to heat the fluid in the fluid body.

In some embodiments, a flexible circuit is attached to the tab circuit side of the fluid cartridge between the contact pads for the heating element.

In some embodiments, the metal insert has a thickness ranging from about 1.5 to about 4 millimeters.

In some embodiments, the metal insert is a stamped metal insert.

An advantage of the disclosed embodiments is that the metal insert is effective to heat or cool the fluid in the cartridge body without direct and prolonged exposure to a heating element having a high heat flux, such as a resistance heating wire.

### BRIEF DESCRIPTION OF THE DRAWINGS

FIG. 1 is a graphical representation of bulk fluid temperature over time and its correlation to an amount of fluid dispensed.

FIG. 2 is a perspective view, not to scale, of a fluid cartridge according to a first embodiment of the disclosure.

FIG. 3 is a partial bottom perspective view, not to scale, of the fluid cartridge of FIG. 2.

FIG. 4 is a partial bottom perspective, exploded view, not to scale, of the fluid cartridge of FIG. 2.

FIG. 5 is a partial bottom perspective view, not to scale, of the fluid cartridge of FIG. 2 showing spring-loaded thermal contacts for a metal insert of the fluid cartridge of FIG.

FIG. 6 is a partial inside perspective view, not to scale, of the fluid cartridge of FIG. 2.

FIG. 7 is a cross-sectional view, not to scale, of the fluid cartridge of FIG. 2.

FIG. 8 is a plan view, not to scale, of an ejection head for the fluid cartridge of FIG. 2.

FIG. 9 is a perspective view, not to scale, of a fluid cartridge according to a second embodiment of the disclosure.

FIG. 10 is a partial bottom perspective view, not to scale, of the fluid cartridge of FIG. 9.

FIG. 11 is a partial bottom perspective view, not to scale, of a cartridge body for the fluid cartridge of FIG. 9.

FIGS. 12 and 13 are partial bottom perspective views, not to scale, of the fluid cartridge of FIG. 9.

FIG. 14 is a partial bottom perspective, exploded view, not to scale, of the fluid cartridge of FIG. 9.

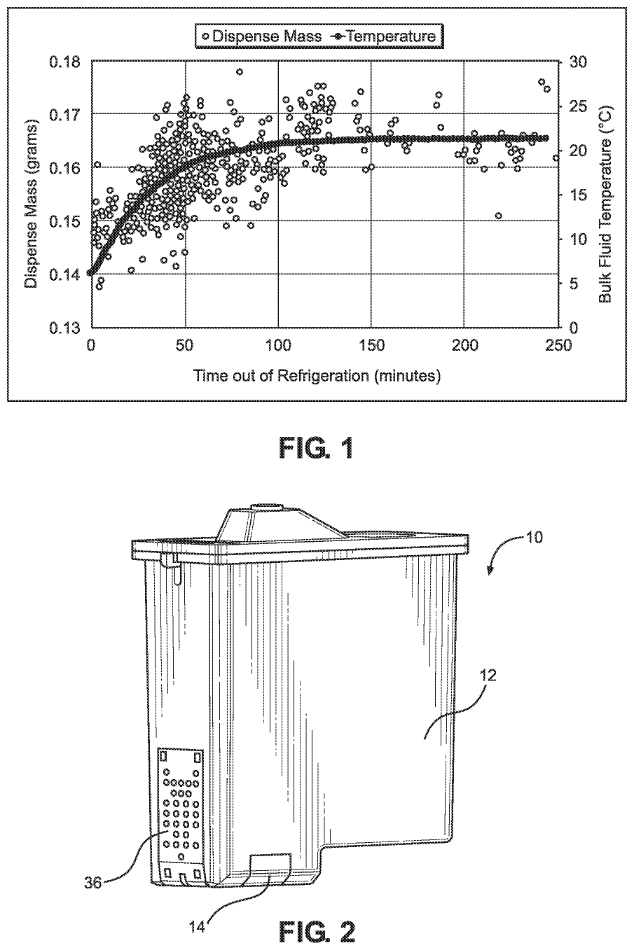

### DETAILED DESCRIPTION OF THE DISCLOSED EMBODIMENTS

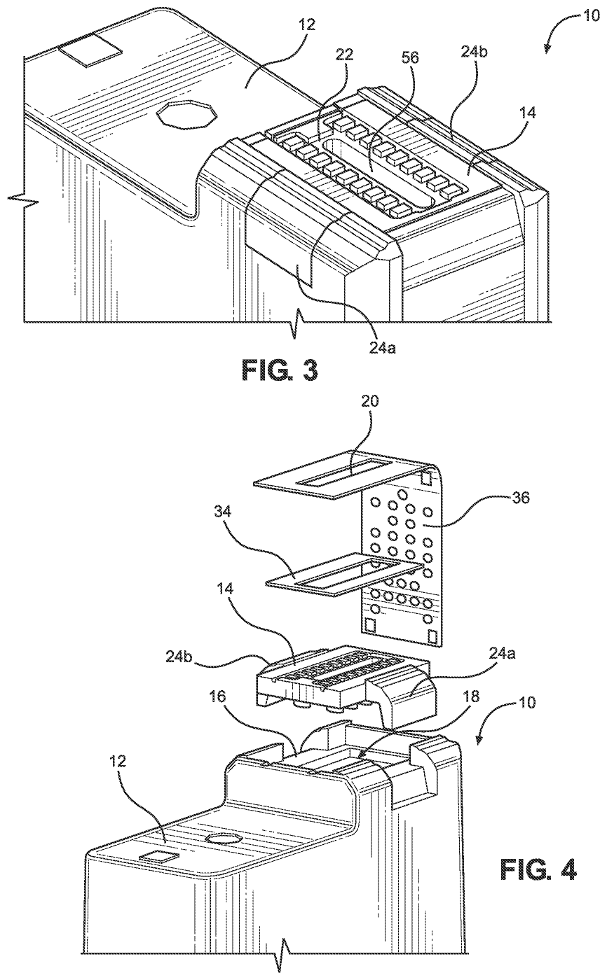

With reference to the figures, FIGS. 2 and 3 are perspective views, not to scale, of a fluid cartridge 10 having a cartridge body 12 and a metal insert 14 attached thereto. FIG. 4 is an exploded, bottom view of the fluid cartridge 10 of FIGS. 2 and 3 according to an embodiment of the disclosure. The cartridge body 12 of the fluid cartridge 10 includes a cartridge body made of a polymeric thermoplastic resin such as polyethylene, polypropylene, polyamide, polystyrene, and the like. As shown in FIG. 4, a bottom wall 16 of the cartridge body 12 contains a fluid supply opening 18 therein for providing fluid from the cartridge body 12 to an ejection head chip 20 that is bonded to the metal insert 14. The metal insert has a fluid supply slot 56 therein corresponding to the fluid supply opening 18. The ejection head chip 20, is attached to a chip pocket 22 on a die bond surface adjacent the fluid supply slot 56 formed in the metal insert 14 using a die bond adhesive as described in more detail below.

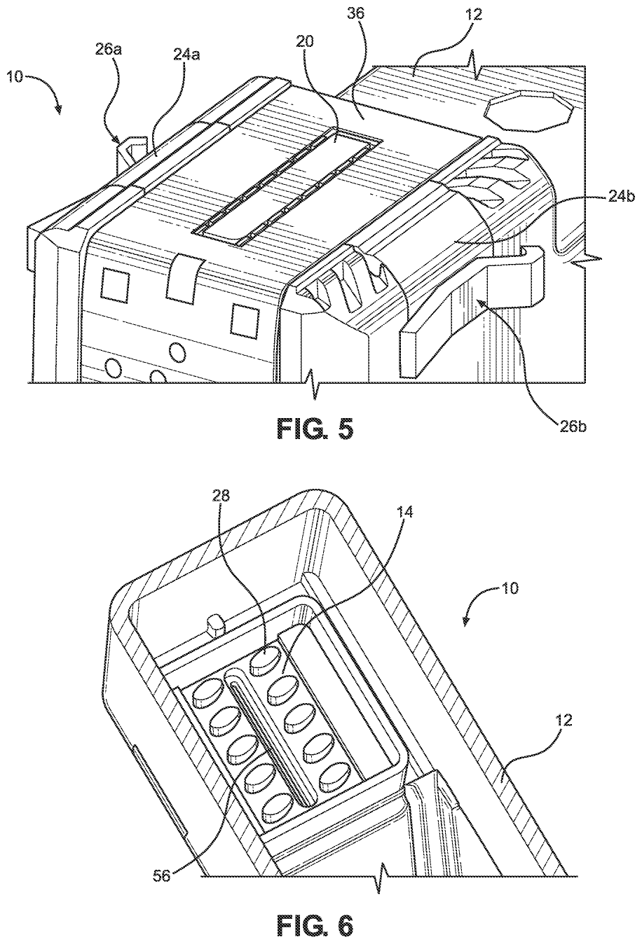

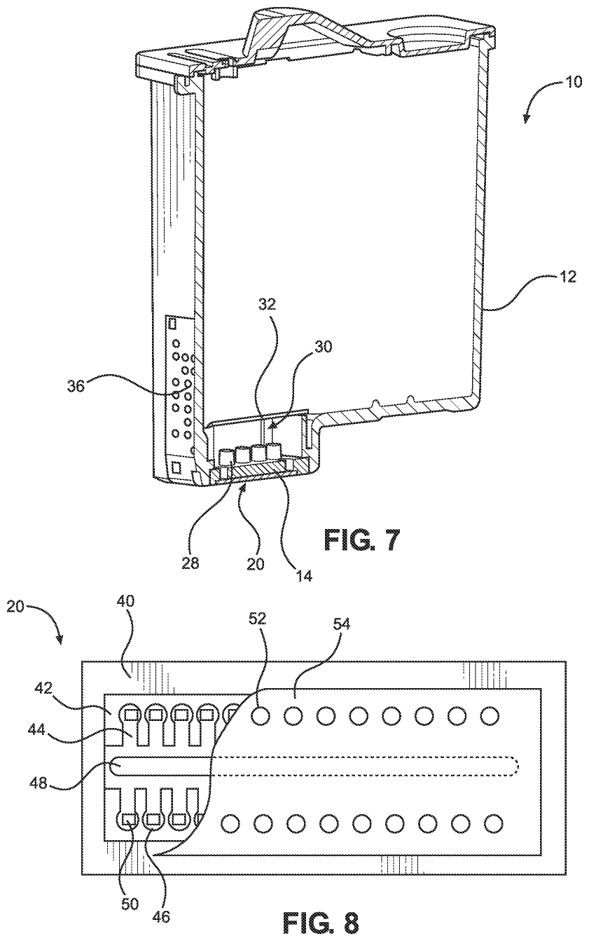

In order to heat and cool fluid in the body 12 of the fluid cartridge 10, the metal insert includes one or more thermal contact extensions 24a and 24b. As shown in FIGS. 2-5, the thermal contact extensions 24a and 24b are adjacent to opposing sides of the body 12 so that when the fluid cartridge 10 is attached to a cartridge holder of a fluid dispensing device, spring-loaded thermal contacts 26a and 26b are in thermal contact with the thermal contact extensions 24a and 24b, respectively. The spring-loaded thermal contacts 26a and 26b may provide heating and cooling to the metal insert 14 by means of a thermoelectric device or other heating and cooling device. In order to improve heat transfer from the metal insert 14 to the fluid in the body 12 of the fluid cartridge 10, a plurality of protrusions 28 may be provided on a side of the metal insert 14 opposite the side of the metal insert to which the ejection head chip 20 is attached as shown in FIGS. 6-7. As shown in more detail in FIG. 7, the protrusions 28 of the metal insert 14 extend into a filter tower area 30 of the cartridge body 12 to adjust the temperature of fluid from the cartridge body 12 flowing into the filter tower area 30 from a filter media 32 before the fluid enters the ejection head chip 20. The protrusions 28 may provide more surface area for more effective heat transfer between the metal insert and the fluid in the cartridge body 12.

The metal insert 14 is fastened by means of a first adhesive to the bottom wall 16 (FIG. 4) of the cartridge body 12. A second adhesive 34 is used to bond a flexible circuit 36 to the metal insert 14 while also insulating the insert from lead beams on the flexible circuit 36. The metal insert 14 has an overall thickness ranging from about 1.5 to about 4 mm in thickness and will typically have a thickness ranging from about 1.75 to about 2.5 mm. The length L of the metal insert 14 may range from about 12 to about 28 mm and the width W of the metal insert 14 may range from about 12 to about 14 mm. A particularly suitable metal insert 14 includes a metal selected from aluminum, steel, copper, tantalum, titanium, and alloys of two or more of the foregoing. In some embodiments, the metal insert 14 is a machined, molded, or stamped metal insert formed from aluminum. The aluminum may be an anodized aluminum or the metal insert may include an inert coating to prevent flocculation of solids from fluids ejected by the ejection head chip 20.

The first adhesive used to attach the metal insert 14 to the bottom wall 16 of the cartridge body 12, may be a heat curable epoxy adhesive that is compatible with the resin used to make the cartridge body 12. In order to enhance adhesion between the metal insert 14 and the bottom wall 16, the underside of the metal insert 14 may be cleaned and treated with water, isopropyl alcohol, or silane. The underside of the metal insert may also be blasted with a high pressure stream of air or aluminum oxide to enhance adhesion. Likewise, the bottom wall 16 of the cartridge body 12 may be coated with an adhesion enhancing coating such as a silane coating.

Once the metal insert 14 is adhesively attached to the bottom wall 16 of the cartridge body 12, the ejection head chip 20 may be adhesively attached to the insert 14 using a die bond adhesive. A conventional ejection head chip 20 is illustrated in FIG. 8 and includes a silicon semiconductor substrate 40 that includes a flow feature layer 42 made from a photoresist material having fluid channels 44 and fluid chambers 46 photoimaged therein. A fluid supply via 48 is etched through the semiconductor substrate 40 and imaged in the flow feature layer 42 and provides fluid to the fluid channels 44 and fluid chambers 46. Each of the fluid chambers 46 includes a fluid ejection device 50 that may be selected from a resistor heater or a piezoelectric device for ejecting fluid from the fluid chambers 46 through associated nozzle holes 52 in a nozzle plate 54 attached to the flow feature layer 42. Because a fluid supply via 48 in the ejection head chip 20 must be precisely aligned with a fluid supply slot 56 in the metal insert 14 in order to provide fluid to fluid ejectors 50 on the fluid ejection chip 20, the chip pocket 22 is provided in the metal insert 14 (FIG. 3) and the ejection head chip 20 is adhesively attached to the metal insert 14 in the chip pocket 22. The chip pocket 22 is a recessed area in the metal insert 14 that provides a somewhat confined area for the die bond adhesive.

The flexible circuit 36, which is used to connect fluid ejectors 50 on the ejection head chip 20 with a control activation device for the fluid ejectors 50, surrounds the ejection head chip 20 and is fastened to the metal insert 14 using the second adhesive 34, also known as a pre-form pressure sensitive adhesive. The flexible circuit 36 includes a plurality of beams which extend therefrom and electrically connect with bond pads (not shown) on the semiconductor substrate 40 of the ejection head chip 20. After the ejection head chip 20 is placed within the chip pocket 22 and the flexible circuit 36 is attached to the ejection head chip 20, an ultraviolet (UV) photosensitive adhesive is applied along the sides of the ejection head chip 20, over the beams, as an encapsulant and protectant to prevent shorting and corrosion from fluid ejected by the ejection head chip 20. A light source is applied to the UV adhesive to cure the same. However, a portion of the UV adhesive which flows around and behind the beams is not exposed to the applied UV light source, and therefore is not cured thereby. Alternatively, a temperature-curing epoxy may be used as an encapsulant for the beams, being backed on after the flexible circuit 36 is electrically bonded to the ejection head chip 20.

Once the fluid cartridge 10 is fully assembled, the fluid cartridge 10 is placed within an oven and the die bond adhesive is cured at an elevated temperature to permanently affix the ejection head chip 20 to the metal insert 14. During the curing process, the adhesive may produce gas which forms gas bubbles in the adhesive. Some of the gas may remain entrapped within the adhesive as residual gas bubbles after the curing process is finished. Such gas bubbles, because of the void left in the adhesive, may affect the bond strength between the ejection head chip 20 and the metal insert 14. Moreover, other gas bubbles may expand at the elevated cure temperature and/or join with adjacent gas bubbles to form passageways or channels within the adhesive. Such a phenomenon, known as “die bond channeling,” may result in channels which extend from the fluid supply slot 56 within the metal insert 14 to the ambient environment, thereby allowing fluid to leak from the fluid cartridge assembly to the ambient environment. Alternatively, in the case of a multi-fluid cartridge assembly, the channels formed in the adhesive may allow cross-contamination between the different fluids within the cartridge body 12.

Additionally, the uncured UV or thermally cured epoxy adhesive is subsequently cured and/or volatilized by the heating process used to cure the die bond adhesive. During the heat curing process, the UV and/or thermally cured epoxy adhesive may also produce gas. Because the UV and/or thermally cured epoxy adhesive placed over the beams on each side of the ejection head chip 20 has previously been cured, and the flexible circuit 36 is affixed to the metal insert 14 and surrounds the ejection head chip 20, gas which is produced during the heat curing process may expand (because of the increased temperature) and flow through the die bond adhesive and UV adhesive toward and into the fluid supply slot 56 within the metal insert 14 creating channels for leaking of fluid from the fluid supply cartridge out to the ambient environment.

Accordingly, the metal insert 14 is configured with at least one air vent, and preferably, a plurality of air vents adjacent to the chip pocket 22 to enable air to escape from the die bond adhesive and/or UV adhesive during the curing process as described in more detail in U.S. Pat. No. 11,865,843, incorporated herein by reference.

If the metal insert 14 has a large thermal capacity, there may be an advantage in having a low thermal resistance to the ejection head chip 20. The temperature rise would be more gradual and lower if the thermal mass of the combined ejection head chip 20 and metal insert 14 is high enough. A more gradual temperature rise is beneficial for temperature sensitive fluids that used in the fluid cartridge 10. If the desire is to regulate the temperature to a lower value than the steady state condition, either with a large thermal mass or through active cooling, a lower thermal resistance die bond adhesive may be used.

An alternative approach would be to use a more insulating die bond adhesive between the ejection head chip 20 and the metal insert 14. In this case the temperature rise of the fluid would be controlled by the metal insert 14. When using a high thermal resistance die bond adhesive, the temperature rise of the fluid could be monitored by the thermal sensors on the ejection head chip 20. Once the target temperature and dwell conditions are met, fluid jetting would be initiated. The fluid jetting temperature could also be controlled by heating the ejection head chip 20. The advantages of using the metal insert 14 is that the bulk fluid and the ejection head chip 20 could be heated to an ambient temperature or to a temperature acceptable for good fluid health to provide an ideal fluid temperature for reliable fluid jetting. A consistent fluid temperature throughout the fluid jetting process is ideal.

For some applications, the fluid cartridge 10 may be stored at temperatures as low as −60° C. For other applications, the fluid cartridge 10 may be stored at temperatures ranging from about 0 to about 10° C. Accordingly, heating fluid suppled to the ejection head chip 20 from the fluid cartridge 10 may require the use of the thermoelectric device as well as substrate heaters to bring the fluid to the ideal jetting temperature. In some cases, cooling of the fluid supplied to the ejection head may be necessary using the thermoelectric device. Accordingly, there may be a balance that is necessary to control the amount of heat provided to the fluid from the substrate heaters and the amount of heating or cooling provided to the fluid from the metal insert 14 in order to maintain an ideal fluid jetting temperature.

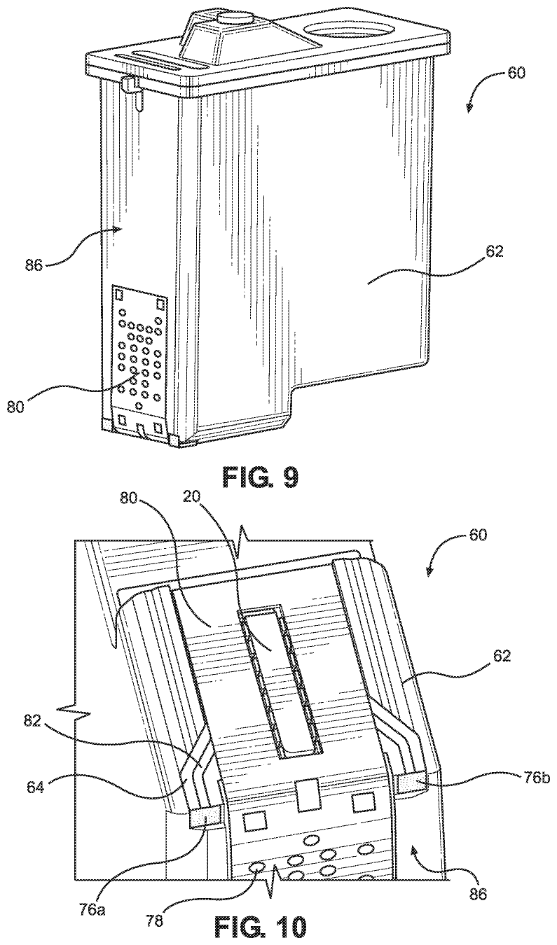

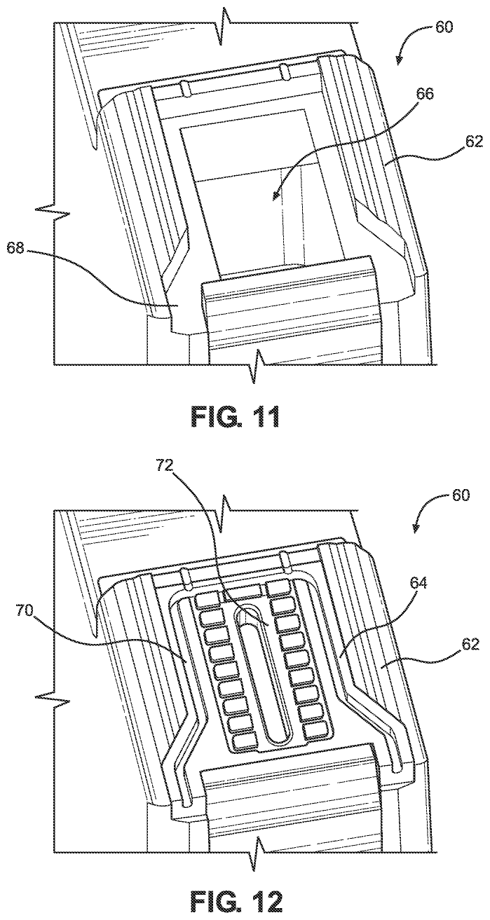

FIGS. 9-14 illustrate another embodiment of the disclosure. FIG. 9 is a perspective view of a fluid cartridge 60 having a cartridge body 62, and a metal insert 64 (FIG. 10) for heating fluid supplied to an ejection head 20 attached to the metal insert 64. As in the previous embodiment, the cartridge body 62 includes a fluid supply opening 66 in the cartridge body 62 and a bottom wall 68 for attaching the metal insert 64 thereto (FIG. 11). The metal insert 64 has the same overall dimensions as the metal insert 14 and also includes protrusions on an opposing side of the metal insert 64 from a chip pocket 72 on the metal insert 64 (FIG. 12).

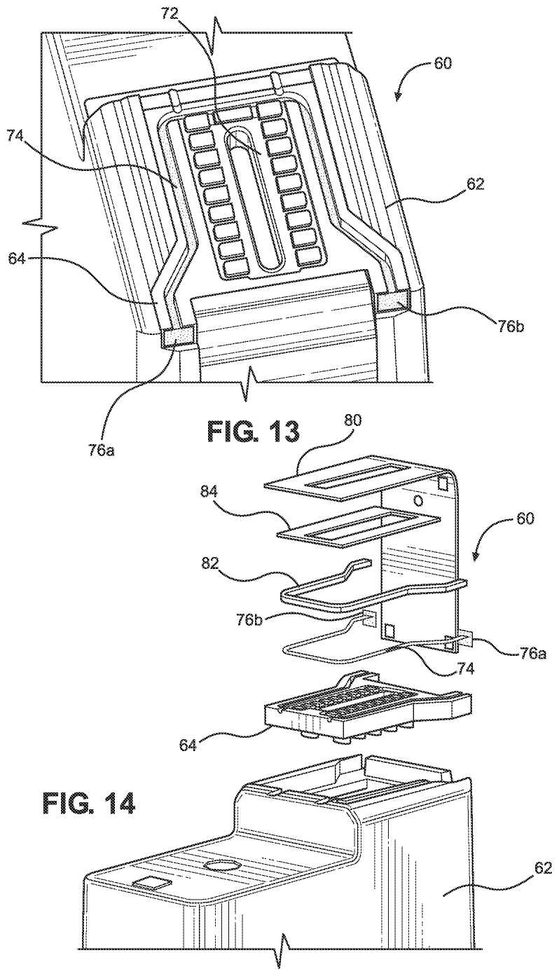

In this embodiment, the metal insert 64 also includes a groove 70 surrounding three sides of a chip pocket 72 formed on the metal insert 64. As shown in FIG. 13, a heating element 74 is embedded in the groove 70. The heating element 74 as a thermoelectric device may be selected from a wide variety of resistive heating element 74 materials including, but not limited to, FeCrAl alloys, NiCr alloys, NiFe alloys, CuNi alloys, and the like and may have an insulative coating applied thereto. A particularly useful heating element 74 is a FeCrAl alloy heating element that may be activated to heat the metal insert 64. The heating element 74 includes electrical contact pads 76a and 76b that may be oriented in a same direction as contact pads 78 on a flexible circuit 80 as shown in FIG. 10 for ease of assembly and use. In another embodiment, the contact pads 76a and 76b may also be oriented on opposing sides of the cartridge body 62. The flexible circuit 80 is attached to a tab circuit side 86 of the fluid cartridge 60.

The heating element 74 for the metal insert 64 may be bonded into the groove using a thermally conductive adhesive 82 selected from high-performance, thermally conductive, thermoset urethanes and epoxies adhesive solutions. Thermoset epoxy and urethane adhesives provide thermally conductive and electrically isolating characteristics that enhance the properties of the heating element 74. Once the adhesive 82 is cured, the ejection head chip 20 can be adhered to the metal insert 64 using a standard die bond adhesive as described above. Alternatively, it may be possible to use a die bond adhesive to cover the heating element 74 at the same time the ejection head chip 20 is placed onto the metal insert 64 so that only one adhesive curing cycle is required.

As described above, a second adhesive 84 is used to bond a flexible circuit 80 to the metal insert 64 while also insulating the metal insert 64 from lead beams on the flexible circuit 80. FIG. 14 provides an exploded view of the construction of the fluid cartridge 60 according to this embodiment of the disclosure.

It is noted that, as used in this specification and the appended claims, the singular forms “a,” “an,” and “the,” include plural referents unless expressly and unequivocally limited to one referent. As used herein, the term “include” and its grammatical variants are intended to be non-limiting, such that recitation of items in a list is not to the exclusion of other like items that can be substituted or added to the listed items

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

What is claimed is:

1. A fluid cartridge comprising:
a cartridge body having a bottom wall having a fluid supply opening therein;
a metal insert adhesively fastened to the bottom wall of the cartridge body, the metal insert having a fluid supply slot therein corresponding to the fluid supply opening in the bottom wall, a die bond surface adjacent to the fluid supply slot configured for adhesively fastening an ejection head chip thereto, wherein the metal insert comprises a heat transfer device selected from the group consisting of a heating element embedded in the metal insert and one or more thermal contact extensions; and
an ejection head chip adhesively fastened to the die bond surface of the metal insert.

2. The fluid cartridge of claim 1, wherein a metal of the metal insert is selected from the group consisting of aluminum, steel, copper, tantalum, titanium, and alloys of two or more of the foregoing.

3. The fluid cartridge of claim 1, wherein the metal insert comprises aluminum.

4. The fluid cartridge of claim 1, wherein the one or more thermal contact extensions are configured to be in thermal contact with a thermoelectric device.

5. The fluid cartridge of claim 4, wherein the one or more thermal contact extensions comprise a first thermal contact extension on a first side of the metal insert, and a second thermal contact extension on a second side of the metal insert, wherein the first and second thermal contact extensions are adjacent to opposing sides of the cartridge body.

6. The fluid cartridge of claim 1, wherein a side of the metal insert opposite the die bond surface of the metal insert further comprises heat transfer protrusions thereon.

7. The fluid cartridge of claim 1, wherein the heating element is embedded in a groove adjacent to three sides of the die bond surface of the metal insert.

8. The fluid cartridge of claim 7, wherein the heating element comprises a material selected from the group consisting of FeCrAl alloys, NiCr alloys, NiFe alloys, CuNi alloys, and the like.

9. The fluid cartridge of claim 1, wherein contact pads for the heating element are disposed on a tab circuit side of the fluid cartridge.

10. The fluid cartridge of claim 9, further comprising a flexible circuit attached to the tab circuit side of the fluid cartridge between the contact pads for the heating element.

11. The fluid cartridge of claim 1, wherein the metal insert has a thickness ranging from about 1.5 to about 4 millimeters.

12. The fluid cartridge of claim 1, wherein the metal insert is a stamped metal insert.

13. A method for heating a fluid in a fluid cartridge comprising:
providing a cartridge body containing the fluid having a bottom wall having a fluid supply opening therein;
attaching a metal insert to the bottom wall of the cartridge body, wherein the metal insert has a fluid supply slot therein corresponding to the fluid supply opening in the bottom wall, a die bond surface adjacent to the fluid supply slot, and a heat transfer device selected from the group consisting of a heating element embedded in the metal insert and one or more thermal contact extensions;
attaching an ejection head chip to the die bond surface of the metal insert;
heating the metal insert using the heat transfer device to adjust a temperature of the fluid being fed to the ejection head from the fluid body through the metal insert.

14. The method of claim 13, wherein the one or more thermal contact extensions comprise a first thermal contact extension on a first side of the metal insert, and a second contact extension on a second side of the metal insert, wherein the first and second thermal contact extensions are adjacent to opposing sides of the cartridge body, further comprising thermally contacting the first and second thermal contact extensions with an activated thermoelectric device to heat the fluid in the fluid body.

15. The method of claim 13, wherein the heating element is embedded in a groove adjacent to three sides of the die bond surface of the metal insert, and contact pads for the heating element are disposed on a tab circuit side of the fluid cartridge, further comprising activating the heating element to heat the fluid in the fluid body.

16. A method for heating or cooling a fluid in a fluid cartridge comprising:
providing a cartridge body containing the fluid having an ejection head bonded to a die bond surface of a metal insert attached to the fluid cartridge; and
heating or cooling the metal insert to heat or cool the fluid on a side of the metal insert opposite the die bond surface of the metal insert.

17. The method of claim 16, wherein the metal insert comprises a heat transfer device selected from the group consisting of a heating element embedded in the metal insert and one or more thermal contact extensions.

18. The method of claim 17, wherein the thermal contact extensions are in thermal contact with a thermoelectric device; further comprising activating the thermoelectric device to heat or cool the fluid in the fluid body.
